(19) United States
(12) Patent Application Publication
(10) Pub. No.: US 2008/0245370 A1
(43) Pub. Date: Oct. 9, 2008

(54) Oxygen mask with rebreather bag for use with pulse oxygen delivery system

(76) Inventors: Danko A. Kobziar, Williamsville, NY (US); Steven M. SanFilippo, Lancaster, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/012,929

(22) Filed: Feb. 6, 2008

Related U.S. Application Data
(60) Provisional application No. 60/899,677, filed on Feb. 6, 2007.

(51) Int. Cl. A62B 7/14

(52) U.S. Cl. 128/206.21

(57) ABSTRACT

A supplemental oxygen system with a rebreather bag in combination with a pulsed delivery system.

### CROSS-REFERENCE TO RELATED APPLICATION

This application claims benefit of U.S. Provisional Patent Application Ser. No. 60/899,677 filed on Feb. 6, 2007, which is incorporated herein by reference.

### FIELD OF THE INVENTION

The present invention generally relates to emergency oxygen supply systems that are routinely carried on commercial aircraft for deployment upon loss of cabin pressure. More particularly, the invention pertains to enhancing the efficiency with which the supplied oxygen is used to thereby reduce the total amount of oxygen that needs to be carried on an aircraft.

### BACKGROUND OF THE INVENTION

Emergency oxygen supply systems are commonly installed on aircraft for the purpose of supplying oxygen to passengers upon loss of cabin pressure at altitudes above about 10,000 feet. Such systems typically include a face mask adapted to fit over the mouth and nose which is released from an overhead storage compartment when needed. Supplemental oxygen delivered by the mask increases the level of blood oxygen saturation in the user beyond what would be experienced if ambient air were breathed at the prevailing cabin pressure altitude condition. The flow of oxygen provided thereby is calculated to be sufficient to sustain users until cabin pressure is reestablished or until a lower, safer altitude can be reached.

Each such face mask has a reservoir bag attached thereto into which a flow of oxygen is directed upon deployment and activation of the system. The oxygen is supplied continuously at a rate that is calculated to accommodate a worst case scenario, namely to satisfy the need of a passenger with a significantly larger than average tidal volume who is breathing at a faster than average respiration rate when cabin pressure is lost at maximum cruising altitude. A total of three valves, which are associated with the mask, serve to coordinate flows between the bag and the mask and between the mask and the surroundings. An inhalation valve serves to confine the oxygen flowing into the bag such that the oxygen remains in the bag while the passenger is exhaling as well as during the post-expiratory pause. When the passenger inhales, the inhalation valve opens to allow for the inhalation of the oxygen that has accumulated in the bag. Upon depletion of the accumulated oxygen, the dilution valve opens to allow cabin air to be drawn into the mask. The continuing flow of oxygen into the bag and through the open inhalation valve into the mask is thereby diluted by the cabin air that is inhaled during the balance of the inhalation phase. During exhalation, the exhalation valve opens to allow a free flow from the mask into the surroundings while the inhalation valve closes to prevent flow from the mask back into the bag. All three valves remain closed during the post-expiratory pause while oxygen continues to flow into the reservoir bag.

Rebreather bags have been used in supplemental oxygen systems to collect part of the exhaled breath to be re-inhaled on the next inhalation. An example is disclosed in U.S. Pat. No. 7,082,946 which is incorporated herein by reference. Another development is pulse oxygen delivery which allows a predetermined amount of oxygen to flow to the mask or a reservoir upon a triggering event such as inhalation demand or exhalation by the user. In contrast to continuous oxygen systems, the flow of oxygen is stopped in a pulse oxygen system until the next triggering event.

What is needed is an oxygen delivery system that is enhanced either in terms of the generation, storage, distribution or consumption of oxygen. Improvements in these areas could therefore yield a weight savings. Also, an enhancement of a system's efficiency without a commensurate downsizing would impart a larger margin of safety in the system's operation. It is therefore highly desirable to enhance the efficiency of an emergency oxygen supply system.

### SUMMARY OF THE INVENTION

The present invention meets the above-described need by providing an oxygen mask with a rebreather bag for use with pulse oxygen delivery. The incorporation of a rebreather bag into an oxygen system based on electronically or pneumatically generated pulse dosing provides the benefit of taking advantage of the previously unused oxygen present in the initial part of the exhaled respiratory volume. By using this discarded oxygen, an equivalent level of safety can be provided to passengers and crew while reducing the oxygen supply flow rates. This provides an economic advantage because less emergency oxygen needs to be carried than for a typical pulse oxygen system. This invention provides an advantage over typical rebreather oxygen systems in that by utilizing a pulse system, a reservoir bag is not necessarily needed and thereby the storage size and weight of the mask system may be reduced. Accordingly, by combining pulse oxygen delivery and a rebreather bag, the efficiency of the supplemental oxygen system is increased.

### BRIEF DESCRIPTION OF THE DRAWINGS

The invention is illustrated in the drawings in which like reference characters designate the same or similar parts throughout the figures of which:

FIG. 1a is a schematic diagram of the supplemental oxygen delivery system of the present invention;

FIG. 1b is an enlarged view of a portion of FIG. 1a;

FIG. 2a is a schematic diagram showing an initial stage of the inhalation portion of the respiratory cycle;

FIG. 2b is a schematic diagram of a second stage of the inhalation portion of the respiratory cycle;

FIG. 2c is a schematic diagram of a third stage of the inhalation portion of the respiratory cycle;

FIG. 3a is a schematic diagram of a first stage of the exhalation portion of the respiratory cycle; and,

FIG. 3b is a schematic diagram of a second stage of the exhalation portion of the respiratory cycle.

### DETAILED DESCRIPTION OF THE INVENTION

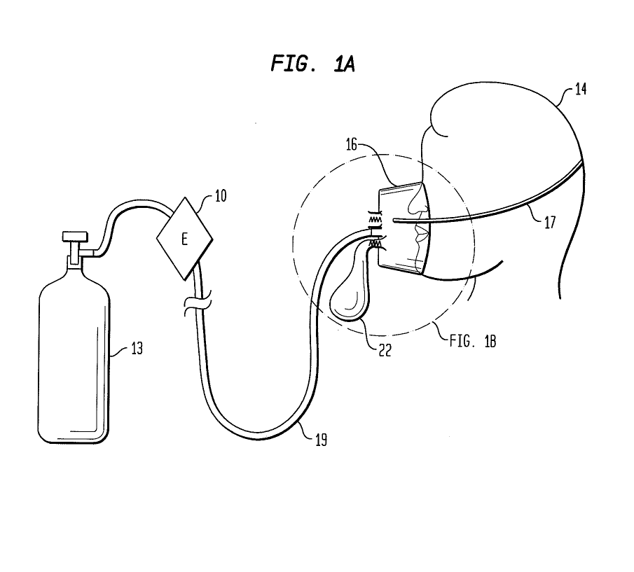

Referring to FIGS. 1a-3b, and initially to FIG. 1a, upon a cabin depressurization event a triggering mechanism (not shown) monitored by oxygen pulse dosing electronics 10 causes a predetermined amount of oxygen to be supplied from a remote supply of oxygen. The remote supply of oxygen shown in FIG. 1a is contained in a storage vessel 13. The supply of oxygen from the storage vessel 13 is supplied to a user 14 of a respiratory protective cover such as an oral-nasal type face mask 16 by means of tubing 19. The respiratory protective cover may also comprise a full face piece or a respiratory hood. The mask 16 is provided with a retention strap 17 to secure the mask 16 over the user's mouth and nose. The oxygen may be delivered directly to the face mask 16 or it may be delivered to a reservoir bag (not shown). In the embodiment shown in FIG. 1a, the oxygen from the tubing 19 is supplied directly to the face mask 16 for the user 14 to inhale at the beginning of the respiratory cycle. If the amount of oxygen supplied from the tubing 19 is less than the inspired volume, the next volume of inspired air will be drawn from the rebreather bag 22 until it is depleted. The rebreather bag 22 may range in size from 200 ml to 600 ml or other sizes as will be evident to those of ordinary skill in the art based on this disclosure. The residual inspired air will be drawn from the ambient atmosphere as described in greater detail below. The mask 16 is provided with either a bi-directional valve 25 or two valves connecting the rebreather bag 22 to the mask 16. The mask 16 is also provided with a bi-directional valve 28 or two valves between the interior of the mask 16 and the ambient environment.

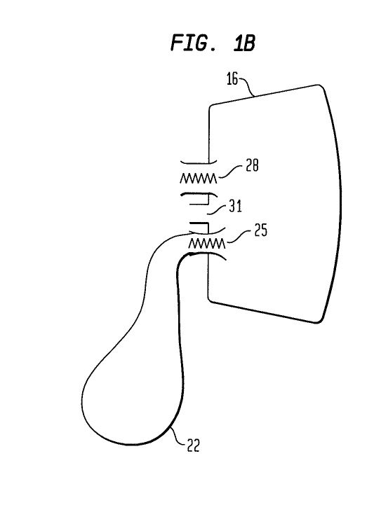

Turning to FIG. 2a, at the beginning of the respiratory cycle a discrete charge of oxygen from the system supply is inhaled through a one way valve 31 or an opening at the center of the mask 16 in the direction of arrow 32.

In FIG. 2b, the second stage is shown wherein the remainder of the inhalation volume is made up of breathing gases from the rebreather bag 22 that are inhaled through valve 25 in the direction of arrow 36.

In FIG. 2c, the third stage (anti-suffocation) of the breathing cycle is shown where ambient air can be pulled through valve 28 in the direction of arrow 39 to supplement the inhalation volume if necessary.

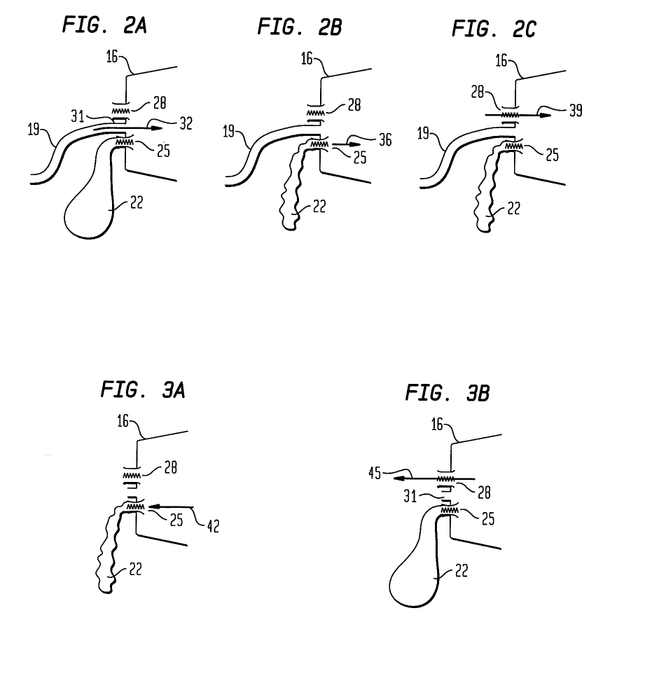

Turning to FIGS. 3a-3b, the exhalation portion of the respiratory cycle is shown. In FIG. 3a, an initial portion of the exhaled air is captured in the rebreather bag 22. The initial portion of exhaled air is air that is not enriched in carbon dioxide or is enriched with little carbon dioxide. As disclosed in U.S. Pat. No. 7,082,946 which is incorporated herein by reference, the exhalation comprises in succession: expelling the “dead volume” that is free from carbon dioxide, a transitory stage, and then a stage in which the alveolar volume is breathed out. The rebreather bag 22 captures the “dead volume” which is that portion of the exhalation volume that does not reach the part of the lungs where gas exchange occurs and therefore can be reused in the next inhalation. The exhalation passes in the direction of arrow 42 through valve 25 into the rebreather bag 22.

As shown in FIG. 3b, once the rebreather bag 22 is filled, the remaining exhalation volume which includes the alveolar volume goes in the direction of arrow 45 to ambient through valve 28.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A supplemental oxygen supply system, comprising:
a respiratory protective cover;
a pulsed oxygen supply disposed in fluid communication with the cover such that respiration by a user causes a discrete charge of oxygen to pass through to the inside of the cover for the user's inspiration;
a re-breather bag disposed in two-way fluid communication with the cover; and,
wherein the cover is disposed in two-way fluid communication with ambient atmosphere.

2. The supplemental oxygen supply system of claim 1, wherein an initial portion of gases exhaled by the user are captured in the re-breather bag.

3. The supplemental oxygen supply system of claim 1, wherein the two-way communication with ambient includes an exhalation valve.

4. The supplemental oxygen supply system of claim 3, further comprising an anti-suffocation valve to allow ambient air to pass through the valve to the interior of the cover.

5. The supplemental oxygen supply system of claim 1, wherein the pulsed oxygen supply is connected directly to the cover.

6. The supplemental oxygen supply system of claim 1, further comprising a reservoir disposed in fluid communication between the pulsed oxygen supply and the cover.

7. The supplemental oxygen supply system of claim 6, further comprising a one-way inhalation valve disposed on the cover.

8. The supplemental oxygen supply system of claim 1, wherein the respiratory protective cover is a half face-piece mask.

9. The supplemental oxygen supply system of claim 1, wherein the respiratory protective cover is a full face-piece mask.

10. The supplemental oxygen supply system of claim 1, wherein the respiratory protective cover is a respiratory hood.

11. A breathing apparatus, comprising:
a respiratory protective cover;
a pulsed oxygen supply disposed in fluid communication with the cover; and,
a re-breather bag disposed in two-way fluid communication with the cover.

12. The breathing apparatus of claim 11, further comprising an anti-suffocation valve.

13. The breathing apparatus of claim 11, further comprising a reservoir for the pulsed oxygen supply.

14. A method of supplying oxygen to a user, the method comprising:
providing a respiratory protective cover;
providing a pulsed oxygen supply disposed in fluid communication with the cover;
providing a re-breather bag disposed in two-way fluid communication with the cover;
proving two-way fluid communication between the interior of the cover and ambient atmosphere;
delivering a discrete charge of breathing gas to the user for the beginning of inspiration;
providing supplemental breathing gas from the re-breather bag to the user in the second stage of inspiration;
providing supplemental breathing gas from the ambient atmosphere via the two-way communication with ambient in the event that the first two stages of the inspiration cycle do not provide sufficient breathing gas to the user;
capturing the initial portion of exhalation from the user in the re-breather bag;
delivering the remaining portion of exhaled gases to ambient via the two-way communication with ambient.

15. The method of claim 14, wherein the cover comprises a half face-piece mask.

16. The method of claim 14, wherein the cover comprises a full face-piece mask.

17. The method of claim 14, wherein the cover comprises a respiratory hood.

18. The method of claim 14, wherein the pulsed oxygen supply is disposed in fluid communication with a reservoir.

19. The method of claim 14, wherein the pulsed oxygen supply is disposed in direct fluid communication with the cover.
